(19) United States
(12) Patent Application Publication
(10) Pub. No.: US 2014/0128103 A1
(43) Pub. Date: May 8, 2014

(54) Apparatus and method for providing information regarding the presence or location of members of a social network

(71) Applicants: Raymond Anthony Joao, Yonkers, NY (US); Robert Richard Bock, Yonkers, NY (US)

(72) Inventors: Raymond Anthony Joao, Yonkers, NY (US); Robert Richard Bock, Yonkers, NY (US)

(21) Appl. No.: 13/694,175

(22) Filed: Nov. 2, 2012

(51) Int. Cl. H04W 4/02

(52) U.S. Cl. CPC H04W 4/023
USPC 455/456.3

(57) ABSTRACT

A computer-implemented method, including processing information regarding a pinging request regarding a first user, storing information regarding a first location or position of a first cellular telephone in a vicinity of the first user, storing information regarding a second location or position of a second cellular telephone in a vicinity of a second user who is a friend, follower, member, or subscriber, of the first user, determining whether the second location or position is within a pre-determined or pre-set distance, range, or radius, of the first location or position, generating a notification message containing information regarding or identifying the second user and a cellular telephone number of the second cellular telephone or an e-mail address of the second user, and transmitting the notification message to the first cellular telephone.

### RELATED APPLICATIONS

This application claims the benefit of priority of U.S. Provisional Patent Application Ser. No. 61/629,003, filed Nov. 12, 2011, and entitled “APPARATUS AND METHOD FOR PROVIDING INFORMATION REGARDING THE PRESENCE OR LOCATION OF MEMBERS OF A SOCIAL NETWORK”, the subject matter and teachings of which are hereby incorporated by reference herein.

### FIELD OF THE INVENTION

The present invention pertains to an apparatus and a method for providing information, or a notification, regarding the presence or the location of one or more individuals, friends, or members, of a social network and, in particular, to an apparatus and a method for providing information, or a notification, to one or more of the individuals, friends, or member, regarding the presence or the location of one or more other individuals, friends, or members, of a social network when at least two individuals, friends, or members, are determined to be in a close geographical proximity, at or near a same venue or event, or at a location in close proximity, to or with one another or to or with another person or individual.

### BACKGROUND OF THE PRESENT INVENTION

Social networking communities and websites and companies that provide same have gained extraordinary popularity in recent years. Hundreds of millions of individuals have joined social networks in recent years as a way to stay in touch with others, to re-connect with friends and other individuals from their past, to meet new people, and to engage in numerous events and activities which can be facilitated by these social networks.

Individuals have come to use social networks to keeps their “friends”, “followers”, or others, apprised of their activities. In spite of the many numerous innovations which have been developed in the on-line social networking field, there is room for improvement.

### SUMMARY OF THE INVENTION

The present invention pertains to an apparatus and a method for providing information, or a notification, regarding the presence or the location of one or more individuals, friends, or members, of a social network and, in particular, to an apparatus and a method for providing information, or a notification, to one or more of the individuals, friends, or member, regarding the presence or the location of one or more other individuals, friends, or members, of a social network when at least two individuals, friends, or members, are determined to be in a close geographical proximity, at or near a same venue or event, or at a location in close proximity, to or with one another or to or with another person or individual.

The present invention can, for example, provide information or a notification to an individual when it is determined that a friend or other member of a social network in a close proximity or at or near a same location as the individual. In this regard, if two individuals are at a same place, venue, event, or location, or in a close proximity to same, the present invention can determine such and can generate and transmit a message to the individual containing information to inform or notify the individual that the person is at the same place, venue, event, or location, or in a close proximity to same, and/or can also provide the individual with the person's cellular phone number, wireless phone number, e-mail address, text messaging information, video-chat or video conferencing information, social networking contact information, information for facilitating a chat or video chat, or any other information which can allow the individual to contact the person or to communicate with the person.

The present invention can be designed to be implemented and/or utilized with or as part of a social network, a social networking group, association, company, or website, by itself, or the present invention can be designed to be implemented and/or utilized with or as part of any number of social networks, social networking groups, associations, companies, or websites.

The apparatus of the present invention can include a central processing computer which can be utilized to store and process any and/or all of the information described herein as being required or desired for facilitating the operation of the apparatus of the present invention and for performing any and/or all of the functions and/or functionality described herein as being performed by the present invention. Any number of central processing computers can be utilized in or with the present invention.

The central processing computer can be, or can include, any computer or any number of computers or any computer system or any number of computer systems deemed necessary or desired for implementing and utilizing the present invention as described herein.

The apparatus of the present invention can also include one or more social network computers each of which can be associated with a social network such as, for example, but not limited to, Facebook, LinkedIn, Classmates, Google Plus, MyLife, MySpace, or any other social networking network, company, organization, or website, a club, a private club, a public club, an organization, an association a school, a college or university, a business, a company, an employer, or any group or association of individuals or business entities who or which may share a common interest or interests or who or which may simply want to be members of the same group or association. A social network computer can be associated with one or more social networks.

Each network computer can be, or can include, any computer or any number of computers or any computer system or any number of computer systems deemed necessary or desired for implementing and utilizing the present invention as described herein.

Each social network computer can be connected to, or linked via, a communication network with, the central processing computer.

The apparatus of the present invention can also include a user computer or communication device which can used by, associated with, or assigned to any user of the present invention, such as, for example, but not limited to, any member or members of any of the social networks described herein.

The user communication device can be, or can include, a cellular telephone, a personal digital assistant, a wireless telephone or a wireless communication device, a personal computer, a tablet computer, a laptop computer, or digital television, an interactive television, a landline telephone, a cordless telephone, or any other device which can be utilized to facilitate communication.

Each user communication device can be linked with or connected with, or can be in communication with, the central processing computer and/or any of the social network computers via any communication network.

Any number of user communication devices can be associated with or used by a user and any number of user communication devices can be used in connection with the present invention.

The apparatus of the present invention can also include one or more cellular communication service provider computers. Each cellular communication service provider computer can be equipped with the necessary hardware and software needed to perform cellular telephone pinging operations, or cellular pinging, in order to determine the location or vicinity of any cellular telephone, wireless telephone, personal digital assistant, or other wireless communication device or computer, which can be used by or associated with any user of the present invention in order to determine a position or location of that user at any given time.

The cellular communication service provider computer can include a cellular pinging system or can be connected to or linked with, and/or can control an operation of a cellular pinging system. The cellular communication service provider computer can include a cellular triangulation system. The cellular communication service provider computer can also be connected to or linked with, and/or can control an operation of a cellular triangulation system.

Each of the cellular communication service provider computers can, for any user of their respective cellular telephone communication network, determine a position or location of that user using cellular pinging technology which is well know to those skilled in the cellular pinging technology art or field.

Each cellular communication service provider computer can be connected with, or linked to, the central processing computer. Each cellular communication service provider computer can also be connected with, or linked to, each social network computer. Each cellular communication service provider computer can also be equipped with the necessary hardware and software needed to determine a location or vicinity of any cellular telephone, wireless telephone, personal digital assistant, or other wireless communication device or computer, using triangulation technology. In this regard, each of the cellular communication service provider computers can, for any user of their respective cellular telephone communication network, determine a position or location of that user using cellular triangulation technology which is also well know to those skilled in the cellular triangulation technology art or field.

The apparatus of the present invention can also include any number of premises computers. Any one or more of the premises computers can be associated with or assigned to any premises, a residential premises, a commercial premises, a private premises, a public premises, a venue or a physical location or a geographical location, a building, a piece of land, a school, a college or university, or any other education or educational venue, a sports or athletic venue, a commercial venue, a store, a shopping center, a shopping mall, a park, a stadium or an arena, a street or a block in a city, village, town, or municipality, a building or location of a goods or service provider for any type or kind of goods or services, a location of a business, a location of a healthcare services provider, or any other premises land, piece or portion of land, or any building or structure, of any type or kind.

Each premises computer can be connected with, or linked to, the central processing computer. Each premises computer can also be connected with, or linked to, or can also be connected with, or linked to, each social network computer.

Each of the central processing computer(s), the social network computers, the user communication devices, the cellular communication service provider computers, and/or the premises computers, can communicate with any other central processing computer(s), social network computers, user communication devices, cellular communication service provider computers, and/or premises computers, via any suitable communication network or system including, but not limited to, the Internet, the World Wide Web, a cellular communication network or system, a wireless Internet communication network or system, a wireless World Wide Web network or system, a telecommunication network or system, a telephone communication network or system, a wireless communication network or system, a wireless Internet network or system, a line or wired communication network or system, a digital communication network or system, a personal communication network or system, a personal communication services (PCS) network or system, a satellite communication network or system, a broad band communication network or system, a low earth orbiting (LEO) satellite network or system, a public switched telephone network or system, a telephone communication network or system, a radio communication network or system, and/or any other communication network or system, and/or any combination of the above communication networks or systems.

The present invention can be utilized on, or over, the Internet and/or the World Wide Web, and/or on, or over, a cellular communication network or system, a wireless Internet communication network or system, a wireless Internet network or system or a wireless World Wide Web network or system. The present invention can also be utilized on, or over, a telecommunication network or system, a telephone communication network or system, a line or wired communication network or system, a digital communication network or system, a personal communication network or system, a personal communication services (PCS) network or system, a satellite communication network or system, a broad band communication network or system, a low earth orbiting (LEO) satellite network or system, a public switched telephone network or system, a telephone communication network or system, a radio communication network or system, and/or any other communication network or system, and/or any combination of the above communication networks or systems.

Each of the central processing computer(s), the social network computers, the user communication devices, the cellular communication service provider computers, and/or the premises computers, can include a central processing device (CPU), a read only memory (ROM) device, a random access memory (RAM) device, an input device, which input device can include any one or more of a keyboard, a mouse, a pointing device, a video input device or a camera, an audio input device or a microphone, a touch screen, a track ball pointing device, or any other device for inputting or entering a data, information, an instruction, or a command, for using or controlling an operation of the respective central processing computer, social network computer, user communication device, cellular communication service provider computer, or premises computer, a display device(s) for displaying data, information, video information, a picture, video, a video clip, or any other data or information, an output device(s), which output device(s) can include a display, a video display screen, a speaker, an audio output device, a printer or any other device which can be used to provide information, a database(s) which can be used to store information regarding any of the herein-described individuals, businesses, entities, or users, of the present invention, including for each of the herein-described individuals, businesses, entities, or users (hereinafter collectively referred to as “user” or “users”), user information, user cellular telephone number(s), user e-mail address(es), user address, information regarding any social network(s) to which the user belongs, information regarding any school or schools the user attended, information regarding any job of jobs the user has had, information regarding any club, organization, group, or association, in which the user is a member, friend, or follower, any of the above-described or herein-described information regarding other users who or which are members of a club, organization, group, or association, in which the user is a member, friend, or follower, any of the above-described or herein-described information regarding family members, friends, acquaintances, social acquaintances, classmates, former classmates, co-workers, former co-workers, or others associated with, any of the users described herein, information regarding employment histories for any of the herein described users or any of the above-described or herein-described family members, friends, acquaintances, social acquaintances, classmates, former classmates, co-workers, former co-workers, or others associated with each user, information regarding any interests, hobbies, pastimes, etc., of or for each user or any of the above-described or herein-described family members, friends, acquaintances, social acquaintances, classmates, former classmates, co-workers, former co-workers, or others associated with each user, information regarding an networking, social networking, or business networking, friends, colleagues, or acquaintances of or for each user or any of the above-described or herein-described family members, friends, acquaintances, social acquaintances, classmates, former classmates, co-workers, former co-workers, or others associated with each user, information regarding any stores, goods or service providers, healthcare providers, hospitals or places for receiving healthcare services, insurance companies, favorite places or venues, selected venues or places of interest, entertainment venues, theatres, concert halls, sports or athletic venues, gyms, fitness facilities, recreational facilities, or any other entities or places of interest, of any of the herein-described users.

The database can also include any data or information typically stored with or provided by any social network of individuals or users, messages or communications, contact information, telephone numbers, e-mail addresses, groups, clubs, associations, employer(s) or school(s), of each user. The database can also store information regarding any location, position, or geographical data or information regarding a location or position of any user, individual, business, entity, or other place or location, which may have or be associated with a fixed location, or any other location. The database can also include any data or information, including, but not limited to global positioning data or information for determining a location or position of any user, individual, business, entity, or other place or location, described-herein, at any time.

Any of the database(s) used in, or associated with, any of the central processing computer(s), the social network computers, the user communication devices, the cellular communication service provider computers, and/or the premises computers, can contain and/or store any portion of, or all, any of the information stored in any other database of the central processing computer(s), the social network computers, the user communication devices, the cellular communication service provider computers, and/or the premises computers, described herein.

Each of the central processing computer(s), the social network computers, the user communication devices, the cellular communication service provider computers, and/or the premises computers, can also include a transmitter(s) for transmitting any of the data, information, video information, audio information, global positioning information, position or location, messages, or any other data or information, to any other central processing computer, social network computer, user communication device, cellular communication service provider computer, or the premises computer, described herein.

Each of the central processing computer(s), the social network computers, the user communication devices, the cellular communication service provider computers, and/or the premises computers, can also include a receiver(s) for receiving any of the data, information, video information, audio information, global positioning information, position or location, messages, or any other data or information, from any other central processing computer, social network computer, user communication device, cellular communication service provider computer, or the premises computer, described herein.

The present invention can be utilized to provide information or a notification to an individual or to a user, or to at least one or more individuals or users, regarding a presence of another person at, in, or in the vicinity of, the individual or the user, or at, in, or the vicinity of, a location, place, or venue, where the individual or user is or happens to be present or located.

For example, if a friend, such a social networking friend, of the individual or user happens to be a same sporting event, sporting venue, shopping mall, store, or other place or location, as the individual or user, the present invention can detect the presence of both the individual or user, and the friend, at, in, or in the vicinity of, the individual or the user, or at, in, or the vicinity of, a location, place, or venue, where the individual or user is or happens to be present or located, can generate a message to inform the individual or user of the presence of his or her friend as being nearby or at, in, or in the vicinity of, the individual or the user, or at, in, or the vicinity of, a location, place, or venue, where the individual or user is or happens to be present or located, and can transmit the message to the user communication device of, used by, or associated with the individual or user. In this manner, the individual or user can be notified or alerted as to the presence of his or her friend being nearby, and the individual or user can either initiate a communication with the user communication device of, used by, or associated with the friend. The individual or user may also use the information so as to avoid coming into contact with the friend.

Any user who is a member of a social network and who desires to utilize the present invention, in order to either be notified regarding the presence, within a pre-determined or a pre-selected distance, range, or radius, of another user or who agrees to have information regarding his, her, or its, presence be provided to other users, can register his, her, or its, cellular telephone number and cellular service provider with the central processing computer and/or the social network computer of the social network to which he, she, or it, belongs. In the case of a company, business entity, venue, or location, or any other user, which may have a stationary location, information regarding its or his or her telephone number, which can be a landline telephone number or a cellular telephone number, address, website, uniform resource locator (url), or any other information, along with its location, can be registered with the central processing computer and/or the social network computer of the social network to which it, belongs.

A user can also identify those other users or members, or groups of users or members, or a social network, of or for any number of social networks with, with whom or which he, she, or it, agrees or desires to utilize the present invention in connection with so that he, she, or it, can either be notified regarding the presence of another user or member or to whom or which he, she, or it, agrees or desires to have information regarding his, her, or its, presence provided.

The user can also pre-select or pre-program the distance, range, or radius, within which he, she, or it, desires to be notified of the presence of other users. For example, if the user is attending a sporting event at a stadium, he, she, or it, may select a distance, range, radius, of between 1000 and 2000 feet so as to be notified of any his or her friends who may be attending the same sporting event or at least be nearby same.

The present invention can also be equipped with hardware and software to determine the location or position of any of the user cellular telephones described herein by utilizing triangulation techniques.

Each of the cellular communication service provider computers can, for any user of their respective cellular telephone communication network, determine a position or location of that user using cellular triangulation technology which is well know to those skilled in the cellular triangulation technology art or field.

The present invention can also be used so that an individual or user who is not friends with, or who desires to avoid a detected person, can be notified of the person's presence so that the individual or user may avoid that person.

The present invention can be utilized in any numbers of applications. The present invention can be utilized in many social networking applications and can also be utilized in any number or types or kinks of marketing applications, healthcare applications, educational applications, applications involving the offering or the providing or any types or kinds of goods and/or services, and/or in matching buyers with sellers.

### BRIEF DESCRIPTION OF THE DRAWINGS

In the Drawings:

FIG. 1 illustrates a preferred embodiment of the apparatus of the present invention, in block diagram form;

FIG. 2 illustrates a preferred embodiment of the central processing computer of FIG. 1, in block diagram form;

FIG. 3 illustrates a preferred embodiment of the social network computer of FIG. 1, in block diagram form;

FIG. 4 illustrates a preferred embodiment of the user communication device of FIG. 1, in block diagram form;

FIG. 5 illustrates a preferred embodiment of the cellular communication service provider computer of FIG. 1, in block diagram form;

FIG. 6 illustrates a preferred embodiment of the premises computer of FIG. 1, in block diagram form; and

FIG. 7 illustrates a preferred embodiment method for using the apparatus of FIG. 1, in flow diagram form.

### DESCRIPTION OF THE PREFERRED EMBODIMENTS

The present invention pertains to an apparatus and a method for providing information, or a notification, regarding the presence or the location of one or more individuals, friends, or members, of a social network and, in particular, to an apparatus and a method for providing information, or a notification, to one or more of the individuals, friends, or member, regarding the presence or the location of one or more other individuals, friends, or members, of a social network when at least two individuals, friends, or members, are determined to be in a close geographical proximity, at or near a same venue or event, or at a location in close proximity, to or with one another or to or with another person or individual.

The apparatus and method of the present invention can, for example, provide information or a notification to an individual when it is determined that a friend or other member of a social network in a close proximity or at or near a same location as the individual. In this regard, if two individuals are at a same place, venue, event, or location, or in a close proximity to same, the apparatus or method of the present invention can determine such and can generate and transmit a message to the individual containing information to inform or notify the individual that the person is at the same place, venue, event, or location, or in a close proximity to same, and/or can also provide the individual with the person's cellular phone number, wireless phone number, e-mail address, text messaging information, video-chat or video conferencing information, social networking contact information, information for facilitating a chat or video chat, or any other information which can allow the individual to contact the person or to communicate with the person.

The apparatus and method of the present invention can be designed to be implemented and/or utilized with or as part of a social network, a social networking group, association, company, or website, by itself, or the apparatus and method of the present invention can be designed to be implemented and/or utilized with or as part of any number of social networks, social networking groups, associations, companies, or websites.

Applicant hereby incorporates by reference herein the subject matter and teachings of U.S. Provisional Patent Application Ser. No. 61/629,003, filed Nov. 12, 2011, and entitled “APPARATUS AND METHOD FOR PROVIDING INFORMATION REGARDING THE PRESENCE OR LOCATION OF MEMBERS OF A SOCIAL NETWORK”.

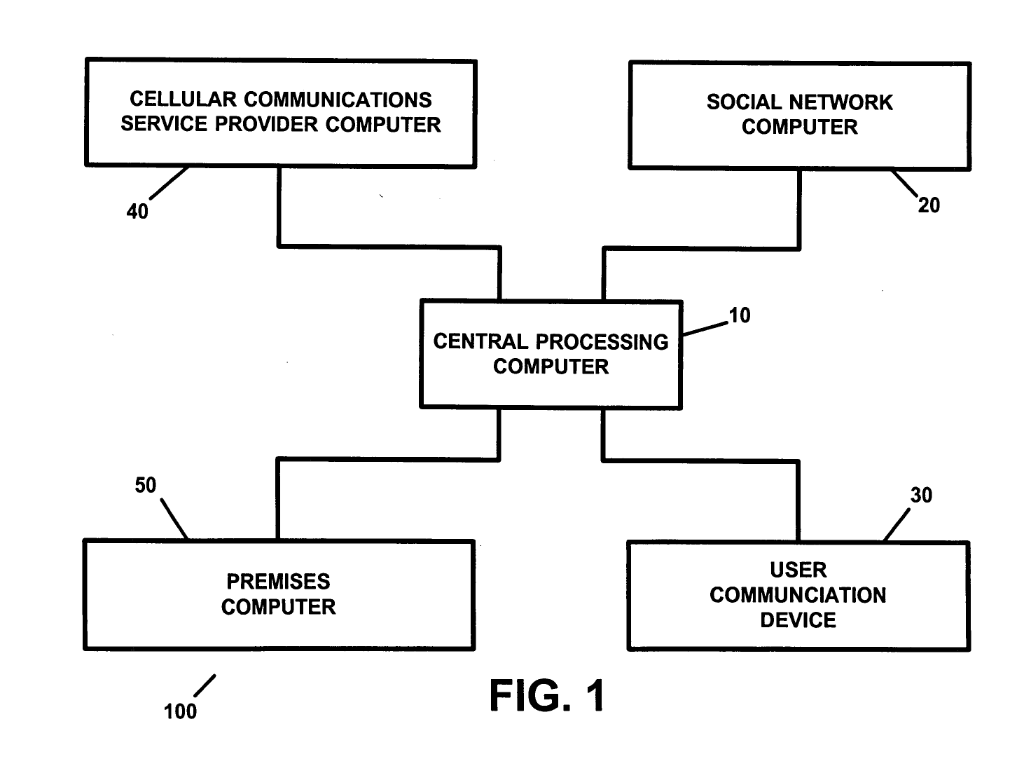

FIG. 1 illustrates a preferred embodiment of the apparatus of the present invention, in block diagram form. The apparatus of FIG. 1 is denoted generally by the reference number 100. With reference to FIG. 1, the apparatus 100 includes a central processing computer 100. The central processing computer 100 can be utilized to store and process any and/or all of the information described herein as being required or desired for facilitating the operation of the apparatus and for performing any and/or all of the functions and/or functionality described herein as being performed by the central processing computer 10 as well as the apparatus 100. Any number of central processing computers 100 can be utilized in or with the apparatus 100.

In the preferred embodiment, the central processing computer 10 can be, or can include, any computer or any number of computers or any computer system or any number of computer systems deemed necessary or desired for implementing and utilizing the apparatus 100 and method of the present invention as described herein.

The apparatus 100 can also contain one or more social network computers 20. Each social network computer 20 can be associated with a social network such as, for example, but not limited to, Facebook, LinkedIn, Classmates, Google Plus, MyLife, MySpace, or any other social networking network, company, organization, or website, a club, a private club, a public club, an organization, an association a school, a college or university, a business, a company, an employer, or any group or association of individuals or business entities who or which may share a common interest or interests or who or which may simply want to be members of the same group or association. A social network computer 20 can be associated with one or more social networks.

In the preferred embodiment, each network computer 20 can be, or can include, any computer or any number of computers or any computer system or any number of computer systems deemed necessary or desired for implementing and utilizing the apparatus 100 and method of the present invention as described herein.

In the preferred embodiment, each social network computer 20 is connected to, or linked via, a communication network with, the central processing computer 100.

The apparatus 100 can also include a user computer or communication device 30 (hereinafter “user communication device 30”) which can used by, associated with, or assigned to any user of the apparatus 100, such as, for example, but not limited to, any member or members of any of the social networks described herein.

As used herein, the term “user” refers to any individual, person, company, business entity, association, group, club, social network, venue, location, friend, member, follower, or any other person, individual, or entity, which utilizes, or is utilized in connection with, the apparatus 100 and method of the present invention.

In the preferred embodiment, the user communication device 30 can be, or can include, a cellular telephone, a personal digital assistant, a wireless telephone or a wireless communication device, a personal computer, a tablet computer, a laptop computer, or digital television, an interactive television, a landline telephone, a cordless telephone, or any other device which can be utilized to facilitate communication.

In the preferred embodiment, each user communication device 30 can be linked with or connected with, or can be in communication with, the central processing computer 10 and/or any of the social network computers 20 via any communication network.

Any number of user communication devices 30 can be associated with or used by a user and any number of user communication devices 30 can be used in connection with the apparatus 100 and method of the present invention.

With reference once again to FIG. 1, the apparatus 100 of the present invention includes one or more cellular communication service provider computers 40. In the preferred embodiment, each cellular communication service provider computer 40 is equipped with the necessary hardware and software needed to perform cellular telephone pinging operations, or cellular pinging, in order to determine the location or vicinity of any cellular telephone, wireless telephone, personal digital assistant, or other wireless communication device or computer, which can be used by or associated with any user of the apparatus 100 in order to determine a position or location of that user at any given time.

In a preferred embodiment, the cellular communication service provider computer 40 can include a cellular pinging system. In another preferred, embodiment, the cellular communication service provider computer 40 can be connected to or linked with, and/or can control an operation of a cellular pinging system.

In a preferred embodiment, the cellular communication service provider computer 40 can include a cellular triangulation system. In another preferred, embodiment, the cellular communication service provider computer 40 can be connected to or linked with, and/or can control an operation of a cellular triangulation system.

Applicant incorporates by reference herein the subject matter and teachings of cellular pinging technology as of the filing date of the present patent application for the present invention. In the preferred embodiment, each of the cellular communication service provider computers 40 can, for any user of their respective cellular telephone communication network, can determine a position or location of that user using cellular pinging technology which is well know to those skilled in the cellular pinging technology art or field.

In the preferred embodiment, each cellular communication service provider computers 40 can be connected with, or linked to, the central processing computer 10. In the preferred embodiment, each cellular communication service provider computers 40 can also be connected with, or linked to, each social network computer 20.

In another preferred embodiment, each cellular communication service provider computer 40 can also be equipped with the necessary hardware and software needed to determine a location or vicinity of any cellular telephone, wireless telephone, personal digital assistant, or other wireless communication device or computer, using triangulation technology. In this regard, each of the cellular communication service provider computers 40 can, for any user of their respective cellular telephone communication network, can determine a position or location of that user using cellular triangulation technology which is also well know to those skilled in the cellular triangulation technology art or field.

With reference still again to FIG. 1, the apparatus 100 also includes any number of premises computers 50. Any one or more of the premises computers 50 can be associated with or assigned to any premises, a residential premises, a commercial premises, a private premises, a public premises, a venue or a physical location or a geographical location, a building, a piece of land, a school, a college or university, or any other education or educational venue, a sports or athletic venue, a commercial venue, a store, a shopping center, a shopping mall, a park, a stadium or an arena, a street or a block in a city, village, town, or municipality, a building or location of a goods or service provider for any type or kind of goods or services, a location of a business, a location of a healthcare services provider, or any other premises land, piece or portion of land, or any building or structure, of any type or kind.

In the preferred embodiment, each premises computer 50 can be connected with, or linked to, the central processing computer 10. In the preferred embodiment, each premises computer 50 can be connected with, or linked to, can also be connected with, or linked to, each social network computer 20.

In a preferred embodiment, each of the central processing computer(s) 10, the social network computers 20, the user communication devices 30, the cellular communication service provider computers 40, and/or the premises computers 50, can communicate with any other central processing computer(s) 10, social network computers 20, user communication devices 30, cellular communication service provider computers 40, and/or premises computers 50, via any suitable communication network or system including, but not limited to, the Internet, the World Wide Web, a cellular communication network or system, a wireless Internet communication network or system, a wireless World Wide Web network or system, a telecommunication network or system, a telephone communication network or system, a wireless communication network or system, a wireless Internet network or system, a line or wired communication network or system, a digital communication network or system, a personal communication network or system, a personal communication services (PCS) network or system, a satellite communication network or system, a broad band communication network or system, a low earth orbiting (LEO) satellite network or system, a public switched telephone network or system, a telephone communication network or system, a radio communication network or system, and/or any other communication network or system, and/or any combination of the above communication networks or systems.

In a preferred embodiment, the apparatus 100 and method of the present invention can be utilized on, or over, the Internet and/or the World Wide Web, and/or on, or over, a cellular communication network or system, a wireless Internet communication network or system, a wireless Internet network or system or a wireless World Wide Web network or system. In another preferred embodiment, the apparatus 100 and method of the present invention can also be utilized on, or over, a telecommunication network or system, a telephone communication network or system, a line or wired communication network or system, a digital communication network or system, a personal communication network or system, a personal communication services (PCS) network or system, a satellite communication network or system, a broad band communication network or system, a low earth orbiting (LEO) satellite network or system, a public switched telephone network or system, a telephone communication network or system, a radio communication network or system, and/or any other communication network or system, and/or any combination of the above communication networks or systems.

In a preferred embodiment, each of the central processing computer(s) 10, the social network computers 20, the user communication devices 30, the cellular communication service provider computers 40, and/or the premises computers 50, can include a central processing device (CPU), a read only memory (ROM) device, a random access memory (RAM) device, an input device, which input device can include any one or more of a keyboard, a mouse, a pointing device, a video input device or a camera, an audio input device or a microphone, a touch screen, a track ball pointing device, or any other device for inputting or entering a data, information, an instruction, or a command, for using or controlling an operation of the respective central processing computer 10, social network computer 20, user communication device 30, cellular communication service provider computer 40, or premises computer 50, a display device(s) for displaying data, information, video information, a picture, video, a video clip, or any other data or information, an output device(s), which output device(s) can include a display, a video display screen, a speaker, an audio output device, a printer or any other device which can be used to provide information, a database(s) which can be used to store information regarding any of the herein-described individuals, businesses, entities, or users, of the present invention, including for each of the herein-described individuals, businesses, entities, or users (hereinafter collectively referred to as “user” or “users”), user information, user cellular telephone number(s), user e-mail address(es), user address, information regarding any social network(s) to which the user belongs, information regarding any school or schools the user attended, information regarding any job of jobs the user has had, information regarding any club, organization, group, or association, in which the user is a member, friend, or follower, any of the above-described or herein-described information regarding other users who or which are members of a club, organization, group, or association, in which the user is a member, friend, or follower, any of the above-described or herein-described information regarding family members, friends, acquaintances, social acquaintances, classmates, former classmates, co-workers, former co-workers, or others associated with, any of the users described herein; information regarding employment histories for any of the herein described users or any of the above-described or herein-described family members, friends, acquaintances, social acquaintances, classmates, former classmates, co-workers, former co-workers, or others associated with each user, information regarding any interests, hobbies, pastimes, etc., of or for each user or any of the above-described or herein-described family members, friends, acquaintances, social acquaintances, classmates, former classmates, co-workers, former co-workers, or others associated with each user, information regarding an networking, social networking, or business networking, friends, colleagues, or acquaintances of or for each user or any of the above-described or herein-described family members, friends, acquaintances, social acquaintances, classmates, former classmates, co-workers, former co-workers, or others associated with each user, information regarding any stores, goods or service providers, healthcare providers, hospitals or places for receiving healthcare services, insurance companies, favorite places or venues, selected venues or places of interest, entertainment venues, theatres, concert halls, sports or athletic venues, gyms, fitness facilities, recreational facilities, or any other entities or places of interest, of any of the herein-described users.

The database can also include any data or information typically stored with or provided by any social network of individuals or users, messages or communications, contact information, telephone numbers, e-mail addresses, groups, clubs, associations, employer(s) or school(s), of each user. The database can also store information regarding any location, position, or geographical data or information regarding a location or position of any user, individual, business, entity, or other place or location, which may have or be associated with a fixed location, or any other location. The database can also include any data or information, including, but not limited to global positioning data or information for determining a location or position of any user, individual, business, entity, or other place or location, described-herein, at any time.

Any of the database(s) used in, or associated with, any of the central processing computer(s) 10, the social network computers 20, the user communication devices 30, the cellular communication service provider computers 40, and/or the premises computers 50, described herein, can contain and/or store any portion of, or all, any of the information stored in any other database of the central processing computer(s) 10, the social network computers 20, the user communication devices 30, the cellular communication service provider computers 40, and/or the premises computers 50, described herein.

In a preferred embodiment, each of the central processing computer(s) 10, the social network computers 20, the user communication devices 30, the cellular communication service provider computers 40, and/or the premises computers 50, can also include a transmitter(s) for transmitting any of the data, information, video information, audio information, global positioning information, position or location, messages, or any other data or information, to any other central processing computer 10, social network computer 20, user communication device 30, cellular communication service provider computer 40, or the premises computer 50 described herein.

In a preferred embodiment, each of the central processing computer(s) 10, the social network computers 20, the user communication devices 30, the cellular communication service provider computers 40, and/or the premises computers 50, can also include a receiver(s) for receiving any of the data, information, video information, audio information, global positioning information, position or location, messages, or any other data or information, from any other central processing computer 10, social network computer 20, user communication device 30, cellular communication service provider computer 40, or the premises computer 50 described herein.

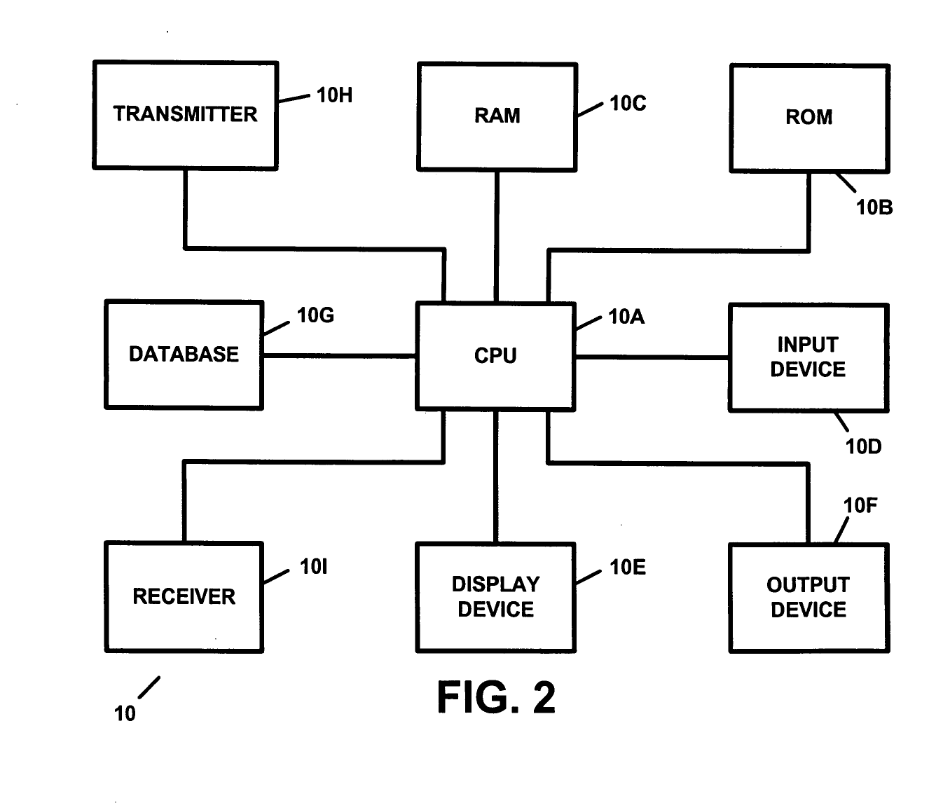

FIG. 2 illustrates a preferred embodiment of the central processing computer 10 of FIG. 1, in block diagram form. With reference to FIG. 2, the central processing computer includes a central processing device (CPU) 10A, a read only memory (ROM) device 10B, a random access memory (RAM) device 10C, an input device 10D, which input device can include any one or more of a keyboard, a mouse, a pointing device, a video input device or a camera, an audio input device or a microphone, a touch screen, a track ball pointing device, or any other device for inputting or entering a data, information, an instruction, or a command, for using or controlling an operation of the respective central processing computer 10, a display device(s) 10E for displaying data, information, video information, a picture, video, a video clip, or any other data or information, an output device(s) 10F, which output device(s) can include a display, a video display screen, a speaker, an audio output device, a printer or any other device which can be used to provide information, a database(s) 10G which can be used to store information regarding any of the herein-described individuals, businesses, entities, or users, of the present invention, including for each of the herein-described individuals, businesses, entities, or users (hereinafter collectively referred to as “user” or “users”), user information, user cellular telephone number(s), user e-mail address(es), user address, information regarding any social network(s) to which the user belongs, information regarding any school or schools the user attended, information regarding any job of jobs the user has had, information regarding any club, organization, group, or association, in which the user is a member, friend, or follower, any of the above-described or herein-described information regarding other users who or which are members of a club, organization, group, or association, in which the user is a member, friend, or follower, any of the above-described or herein-described information regarding family members, friends, acquaintances, social acquaintances, classmates, former classmates, co-workers, former co-workers, or others associated with, any of the users described herein, information regarding employment histories for any of the herein described users or any of the above-described or herein-described family members, friends, acquaintances, social acquaintances, classmates, former classmates, co-workers, former co-workers, or others associated with each user, information regarding any interests, hobbies, pastimes, etc., of or for each user or any of the above-described or herein-described family members, friends, acquaintances, social acquaintances, classmates, former classmates, co-workers, former co-workers, or others associated with each user, information regarding an networking, social networking, or business networking, friends, colleagues, or acquaintances of or for each user or any of the above-described or herein-described family members, friends, acquaintances, social acquaintances, classmates, former classmates, co-workers, former co-workers, or others associated with each user, information regarding any stores, goods or service providers, healthcare providers, hospitals or places for receiving healthcare services, insurance companies, favorite places or venues, selected venues or places of interest, entertainment venues, theatres, concert halls, sports or athletic venues, gyms, fitness facilities, recreational facilities, or any other entities or places of interest, of any of the herein-described users. The database 10G can also include any data or information typically stored with or provided by any social network of individuals or users, messages or communications, contact information, telephone numbers, e-mail addresses, groups, clubs, associations, employer(s) or school(s), of each user. The database 10G can also store information regarding any location, position, or geographical data or information regarding a location or position of any user, individual, business, entity, or other place or location, which may have or be associated with a fixed location, or any other location. The database can also include any data or information, including, but not limited to global positioning data or information for determining a location or position of any user, individual, business, entity, or other place or location, described-herein, at any time.

The database 10G can contain and/or store any portion of, or all, any of the information stored in any other database of the central processing computer(s) 10, the social network computers 20, the user communication devices 30, the cellular communication service provider computers 40, and/or the premises computers 50, described herein.

With reference once again to FIG. 2, the central processing computer 10 also includes a transmitter(s) 10H for transmitting any of the data, information, video information, audio information, global positioning information, position or location, messages, or any other data or information, to any other central processing computer 10, to any of the social network computers 20, to any of the user communication devices 30, to any of the cellular communication service provider computers 40, or to any of the premises computers 50, described herein. The transmitter 10H can be or can include one or more separate transmitters or individual transmitters.

In a preferred embodiment, the central processing computer 10, also includes a receiver 10I for receiving any of the data, information, video information, audio information, global positioning information, position or location, messages, or any other data or information, from any other central processing computer 10, from any of the social network computers 20, from any of the user communication devices 30, from any of the cellular communication service provider computers 40, or from any of the premises computer 50, described herein. The receiver 10I can be or can include one or more separate receivers or individual receivers.

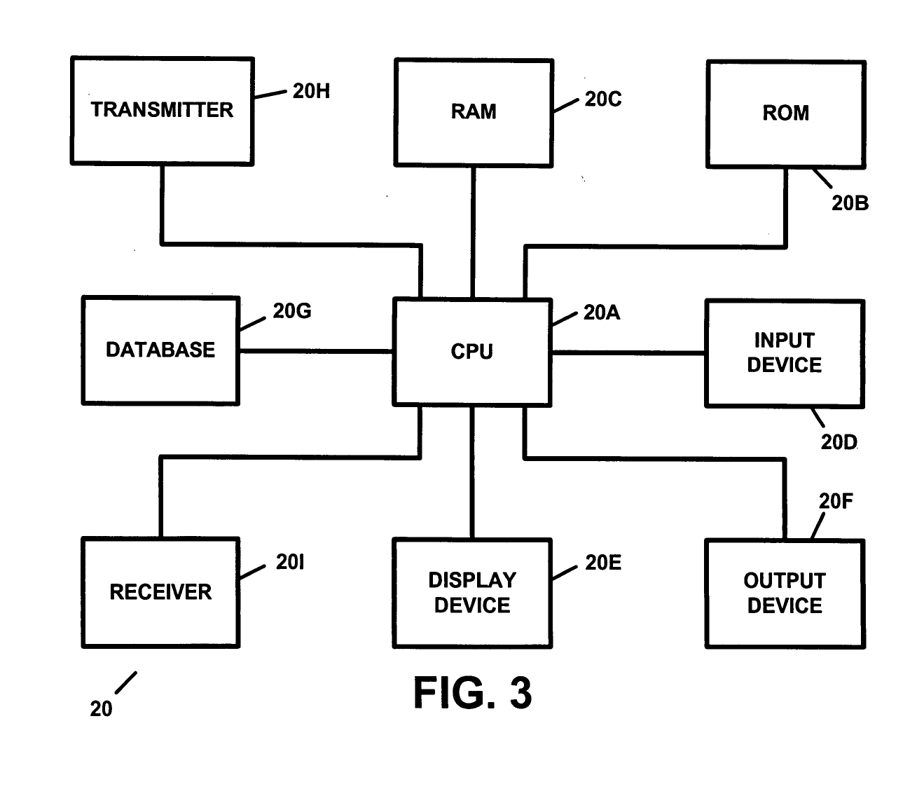

FIG. 3 illustrates a preferred embodiment of a social network computer 20 of FIG. 1, in block diagram form. With reference to FIG. 3, the social network computer 20 includes a central processing device (CPU) 20A, a read only memory (ROM) device 20B, a random access memory (RAM) device 20C, an input device 20D, which input device can include any one or more of a keyboard, a mouse, a pointing device, a video input device or a camera, an audio input device or a microphone, a touch screen, a track ball pointing device, or any other device for inputting or entering a data, information, an instruction, or a command, for using or controlling an operation of the respective social network computer 20, a display device(s) 20E for displaying data, information, video information, a picture, video, a video clip, or any other data or information, an output device(s) 20F, which output device(s) can include a display, a video display screen, a speaker, an audio output device, a printer or any other device which can be used to provide information, a database(s) 20G which can be used to store information regarding any of the herein-described individuals, businesses, entities, or users, of the present invention, including for each of the herein-described individuals, businesses, entities, or users (hereinafter collectively referred to as “user” or “users”), user information, user cellular telephone number(s), user e-mail address(es), user address, information regarding any social network(s) to which the user belongs, information regarding any school or schools the user attended, information regarding any job of jobs the user has had, information regarding any club, organization, group, or association, in which the user is a member, friend, or follower, any of the above-described or herein-described information regarding other users who or which are members of a club, organization, group, or association, in which the user is a member, friend, or follower, any of the above-described or herein-described information regarding family members, friends, acquaintances, social acquaintances, classmates, former classmates, co-workers, former co-workers, or others associated with, any of the users described herein, information regarding employment histories for any of the herein described users or any of the above-described or herein-described family members, friends, acquaintances, social acquaintances, classmates, former classmates, co-workers, former co-workers, or others associated with each user, information regarding any interests, hobbies, pastimes, etc., of or for each user or any of the above-described or herein-described family members, friends, acquaintances, social acquaintances, classmates, former classmates, co-workers, former co-workers, or others associated with each user, information regarding an networking, social networking, or business networking, friends, colleagues, or acquaintances of or for each user or any of the above-described or herein-described family members, friends, acquaintances, social acquaintances, classmates, former classmates, co-workers, former co-workers, or others associated with each user, information regarding any stores, goods or service providers, healthcare providers, hospitals or places for receiving healthcare services, insurance companies, favorite places or venues, selected venues or places of interest, entertainment venues, theatres, concert halls, sports or athletic venues, gyms, fitness facilities, recreational facilities, or any other entities or places of interest, of any of the herein-described users.

The database 20G can also include any data or information typically stored with or provided by any social network of individuals or users, messages or communications, contact information, telephone numbers, e-mail addresses, groups, clubs, associations, employer(s) or school(s), of each user. The database 10G can also store information regarding any location, position, or geographical data or information regarding a location or position of any user, individual, business, entity, or other place or location, which may have or be associated with a fixed location, or any other location. The database 20G can also include any data or information, including, but not limited to global positioning data or information for determining a location or position of any user, individual, business, entity, or other place or location, described-herein, at any time.

The database 20G can contain and/or store any portion of, or all, any of the information stored in any other database of the central processing computer(s) 10, any other social network computers 20, the user communication devices 30, the cellular communication service provider computers 40, and/or the premises computers 50, described herein.

With reference once again to FIG. 3, the social network computer 20 also includes a transmitter(s) 20H for transmitting any of the data, information, video information, audio information, global positioning information, position or location, messages, or any other data or information, to any central processing computer 10, to any other social network computers 20, to any of the user communication devices 30, to any of the cellular communication service provider computers 40, or to any of the premises computers 50, described herein. The transmitter 20H can be or can include one or more separate transmitters or individual transmitters.

In a preferred embodiment, the social network computer 20, also includes a receiver 201 for receiving any of the data, information, video information, audio information, global positioning information, position or location, messages, or any other data or information, from any central processing computer 10, from any other the social network computers 20, from any of the user communication devices 30, from any of the cellular communication service provider computers 40, or from any of the premises computer 50, described herein. The receiver 201 can be or can include one or more separate receivers or individual receivers.

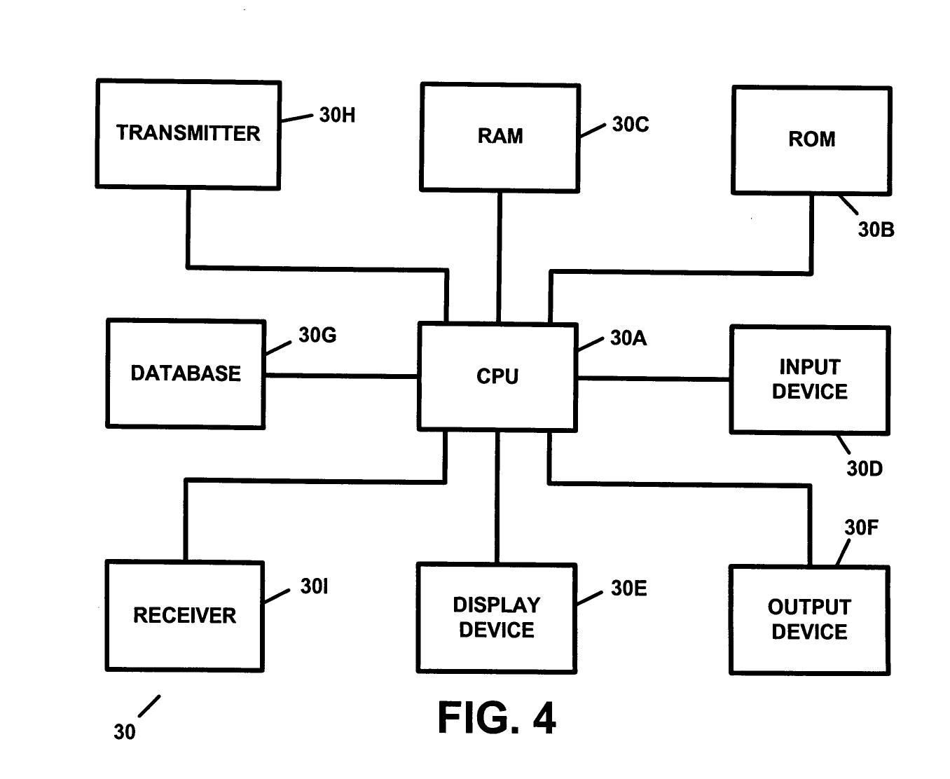

FIG. 4 illustrates a preferred embodiment of a user communication device 30 of FIG. 1, in block diagram form. With reference to FIG. 4, the user communication device 30 includes a central processing device (CPU) 40A, a read only memory (ROM) device 30B, a random access memory (RAM) device 30C, an input device 30D, which input device 30E can include any one or more of a keyboard, a mouse, a pointing device, a video input device or a camera, an audio input device or a microphone, a touch screen, a track ball pointing device, or any other device for inputting or entering a data, information, an instruction, or a command, for using or controlling an operation of the respective user communication device 30, a display device(s) 30E for displaying data, information, video information, a picture, video, a video clip, or any other data or information, an output device(s) 30F, which output device(s) can include a display, a video display screen, a speaker, an audio output device, a printer or any other device which can be used to provide information, a database(s) 30G which can be used to store information regarding any of the herein-described individuals, businesses, entities, or users, of the present invention, including for each of the herein-described individuals, businesses, entities, or users (hereinafter collectively referred to as “user” or “users”), user information, user cellular telephone number(s), user e-mail address(es), user address, information regarding any social network(s) to which the user belongs, information regarding any school or schools the user attended, information regarding any job of jobs the user has had, information regarding any club, organization, group, or association, in which the user is a member, friend, or follower, any of the above-described or herein-described information regarding other users who or which are members of a club, organization, group, or association, in which the user is a member, friend, or follower, any of the above-described or herein-described information regarding family members, friends, acquaintances, social acquaintances, classmates, former classmates, co-workers, former co-workers, or others associated, with, any of the users described herein, information regarding employment histories for any of the herein described users or any of the above-described or herein-described family members, friends, acquaintances, social acquaintances, classmates, former classmates, co-workers, former co-workers, or others associated with each user, information regarding any interests, hobbies, pastimes, etc., of or for each user or any of the above-described or herein-described family members, friends, acquaintances, social acquaintances, classmates, former classmates, co-workers, former co-workers, or others associated with each user, information regarding an networking, social networking, or business networking, friends, colleagues, or acquaintances of or for each user or any of the above-described or herein-described family members, friends, acquaintances, social acquaintances, classmates, former classmates, co-workers, former co-workers, or others associated with each user, information regarding any stores, goods or service providers, healthcare providers, hospitals or places for receiving healthcare services, insurance companies, favorite places or venues, selected venues or places of interest, entertainment venues, theatres, concert halls, sports or athletic venues, gyms, fitness facilities, recreational facilities, or any other entities or places of interest, of any of the herein-described users. The database 30G can also include any data or information typically stored with or provided by any social network of individuals or users, messages or communications, contact information, telephone numbers, e-mail addresses, groups, clubs, associations, employer(s) or school(s), of each user.

The database 30G can also store information regarding any location, position, or geographical data or information regarding a location or position of any user, individual, business, entity, or other place or location, which may have or be associated with a fixed location, or any other location. The database 30G can also include any data or information, including, but not limited to global positioning data or information for determining a location or position of any user, individual, business, entity, or other place or location, described-herein, at any time.

The database 30G can contain and/or store any portion of, or all, any of the information stored in any other database of the central processing computer(s) 10, the social network computers 20, any other user communication devices 30, the cellular communication service provider computers 40, and/or the premises computers 50, described herein.

With reference once again to FIG. 4, the user communication device 30 also includes a transmitter(s) 30H for transmitting any of the data, information, video information, audio information, global positioning information, position or location, messages, or any other data or information, to any central processing computer 10, to any social network computers 20, to any other user communication devices 30, to any of the cellular communication service provider computers 40, or to any of the premises computers 50, described herein. The transmitter 30H can be or can include one or more separate transmitters or individual transmitters.

In a preferred embodiment, the user communication device 30, also includes a receiver 301 for receiving any of the data, information, video information, audio information, global positioning information, position or location, messages, or any other data or information, from any central processing computer 10, from any social network computers 20, from any other user communication devices 30, from any of the cellular communication service provider computers 40, or from any of the premises computer 50, described herein. The receiver 301 can be or can include one or more separate receivers or individual receivers.

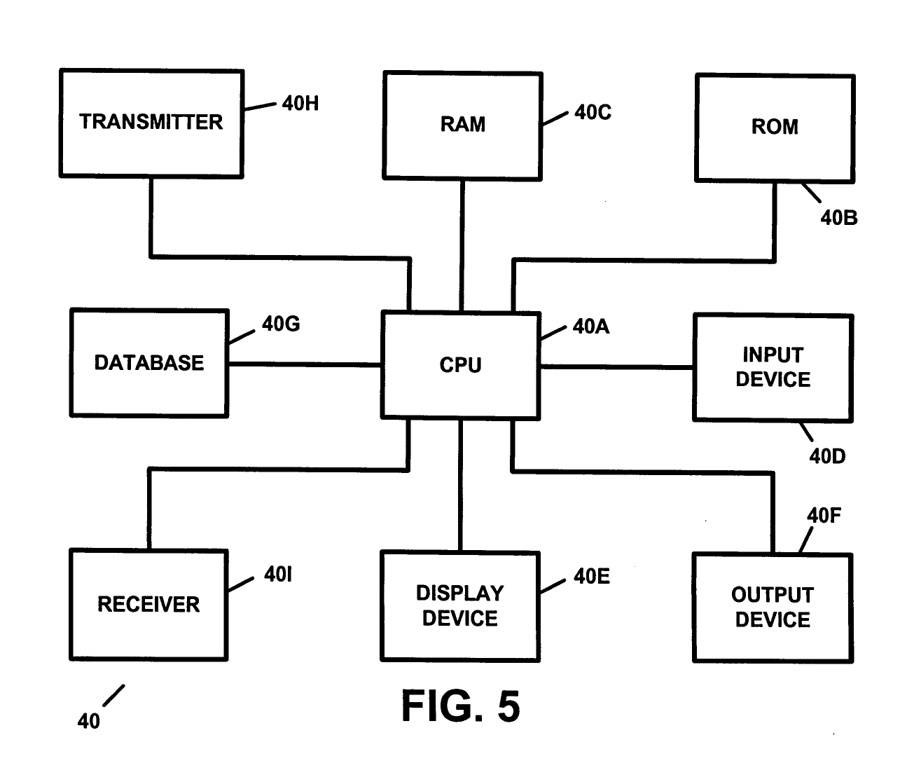

FIG. 5 illustrates a preferred embodiment of a cellular communication service provider computer 40 of FIG. 1, in block diagram form. With reference to FIG. 5, the cellular communication service provider computer 40 includes a central processing device (CPU) 40A, a read only memory (ROM) device 40B, a random access memory (RAM) device 40C, an input device 40D, which input device can include any one or more of a keyboard, a mouse, a pointing device, a video input device or a camera, an audio input device or a microphone, a touch screen, a track ball pointing device, or any other device for inputting or entering a data, information, an instruction, or a command, for using or controlling an operation of the respective cellular communication service provider computer 40, a display device(s) 40E for displaying data, information, video information, a picture, video, a video clip, or any other data or information, an output device(s) 40F, which output device(s) can include a display, a video display screen, a speaker, an audio output device, a printer or any other device which can be used to provide information, a database(s) 40G which can be used to store information regarding any of the herein-described individuals, businesses, entities, or users, of the present invention, including for each of the herein-described individuals, businesses, entities, or users (hereinafter collectively referred to as “user” or “users”), user information, user cellular telephone number(s), user e-mail address(es), user address, information regarding any social network(s) to which the user belongs, information regarding any school or schools the user attended, information regarding any job of jobs the user has had, information regarding any club, organization, group, or association, in which the user is a member, friend, or follower, any of the above-described or herein-described information regarding other users who or which are members of a club, organization, group, or association, in which the user is a member, friend, or follower, any of the above-described or herein-described information regarding family members, friends, acquaintances, social acquaintances, classmates, former classmates, co-workers, former co-workers, or others associated with, any of the users described herein, information regarding employment histories for any of the herein described users or any of the above-described or herein-described family members, friends, acquaintances, social acquaintances, classmates, former classmates, co-workers, former co-workers, or others associated with each user, information regarding any interests, hobbies, pastimes, etc., of or for each user or any of the above-described or herein-described family members, friends, acquaintances, social acquaintances, classmates, former classmates, co-workers, former co-workers, or others associated with each user, information regarding an networking, social networking, or business networking, friends, colleagues, or acquaintances of or for each user or any of the above-described or herein-described family members, friends, acquaintances, social acquaintances, classmates, former classmates, co-workers, former co-workers, or others associated with each user, information regarding any stores, goods or service providers, healthcare providers, hospitals or places for receiving healthcare services, insurance companies, favorite places or venues, selected venues or places of interest, entertainment venues, theatres, concert halls, sports or athletic venues, gyms, fitness facilities, recreational facilities, or any other entities or places of interest, of any of the herein-described users. The database 40G can also include any data or information typically stored with or provided by any social network of individuals or users, messages or communications, contact information, telephone numbers, e-mail addresses, groups, clubs, associations, employer(s) or school(s), of each user.

The database 40G can also store information regarding any location, position, or geographical data or information regarding a location or position of any user, individual, business, entity, or other place or location, which may have or be associated with a fixed location, or any other location. The database 40G can also include any data or information, including, but not limited to global positioning data or information for determining a location or position of any user, individual, business, entity, or other place or location, described-herein, at any time.

The database 40G can contain and/or store any portion of, or all, any of the information stored in any other database of the central processing computer(s) 10, the social network computers 20, the user communication devices 30, any other cellular communication service provider computers 40, and/or the premises computers 50, described herein.

With reference once again to FIG. 5, the cellular communication service provider computer 40 also includes a transmitter(s) 40H for transmitting any of the data, information, video information, audio information, global positioning information, position or location, messages, or any other data or information, to any central processing computer 10, to any social network computers 20, to any user communication devices 30, to any other cellular communication service provider computers 40, or to any of the premises computers 50, described herein. The transmitter 40H can be or can include one or more separate transmitters or individual transmitters.

In a preferred embodiment, the cellular communication service provider computer 40, also includes a receiver 401 for receiving any of the data, information, video information, audio information, global positioning information, position or location, messages, or any other data or information, from any central processing computer 10, from any social network computers 20, from any user communication devices 30, from any other cellular communication service provider computers 40, or from any of the premises computer 50, described herein. The receiver 401 can be or can include one or more separate receivers or individual receivers.

In a preferred embodiment, the cellular communication service provider computer 40 can include a cellular pinging system (not shown) and/or can control an operation of a cellular pinging system and/or can transmit data and/or information to the cellular pinging system and/or can receive data and/or information from the cellular pinging system. In a preferred embodiment, the cellular communication service provider computer 40 can include a cellular triangulation system (not shown) and/or can control an operation of a cellular triangulation system and/or can transmit data and/or information to the cellular triangulation system and/or can receive data and/or information from the cellular triangulation system.

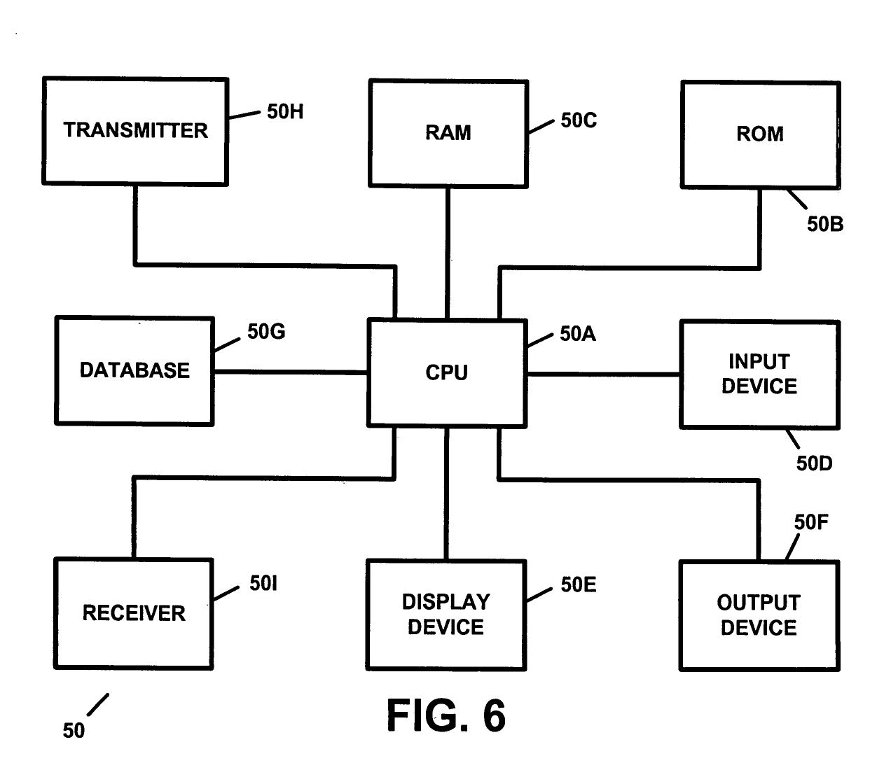

FIG. 6 illustrates a preferred embodiment of a premises computer 50 of FIG. 1, in block diagram form. With reference to FIG. 6, the cellular communication service provider computer 50 includes a central processing device (CPU) 50A, a read only memory (ROM) device 50B, a random access memory (RAM) device 50C, an input device 50D, which input device can include any one or more of a keyboard, a mouse, a pointing device, a video input device or a camera, an audio input device or a microphone, a touch screen, a track ball pointing device, or any other device for inputting or entering a data, information, an instruction, or a command, for using or controlling an operation of the respective premises computer 50, a display device(s) 50E for displaying data, information, video information, a picture, video, a video clip, or any other data or information, an output device(s) 50F, which output device(s) can include a display, a video display screen, a speaker, an audio output device, a printer or any other device which can be used to provide information, a database(s) 50G which can be used to store information regarding any of the herein-described individuals, businesses, entities, or users, of the present invention, including for each of the herein-described individuals, businesses, entities, or users (hereinafter collectively referred to as “user” or “users”), user information, user cellular telephone number(s), user e-mail address(es), user address, information regarding any social network(s) to which the user belongs, information regarding any school or schools the user attended, information regarding any job of jobs the user has had, information regarding any club, organization, group, or association, in which the user is a member, friend, or follower, any of the above-described or herein-described information regarding other users who or which are members of a club, organization, group, or association, in which the user is a member, friend, or follower, any of the above-described or herein-described information regarding family members, friends, acquaintances, social acquaintances, classmates, former classmates, co-workers, former co-workers, or others associated with, any of the users described herein, information regarding employment histories for any of the herein described users or any of the above-described or herein-described family members, friends, acquaintances, social acquaintances, classmates, former classmates, co-workers, former co-workers, or others associated with each user, information regarding any interests, hobbies, pastimes, etc., of or for each user or any of the above-described or herein-described family members, friends, acquaintances, social acquaintances, classmates, former classmates, co-workers, former co-workers, or others associated with each user, information regarding an networking, social networking, or business networking, friends, colleagues, or acquaintances of or for each user or any of the above-described or herein-described family members, friends, acquaintances, social acquaintances, classmates, former classmates, co-workers, former co-workers, or others associated with each user, information regarding any stores, goods or service providers, healthcare providers, hospitals or places for receiving healthcare services, insurance companies, favorite places or venues, selected venues or places of interest, entertainment venues, theatres, concert halls, sports or athletic venues, gyms, fitness facilities, recreational facilities, or any other entities or places of interest, of any of the herein-described users.

The database 50G can also include any data or information typically stored with or provided by any social network of individuals or users, messages or communications, contact information, telephone numbers, e-mail addresses, groups, clubs, associations, employer(s) or school(s), of each user. The database 50F can also store information regarding any location, position, or geographical data or information regarding a location or position of any user, individual, business, entity, or other place or location, which may have or be associated with a fixed location, or any other location. The database 50G can also include any data or information, including, but not limited to global positioning data or information for determining a location or position of any user, individual, business, entity, or other place or location, described-herein, at any time.

The database 50G can contain and/or store any portion of, or all, any of the information stored in any other database of the central processing computer(s) 10, the social network computers 20, the user communication devices 30, any other cellular communication service provider computers 40, and/or the premises computers 50, described herein.

With reference once again to FIG. 6, the premises computer 50 also includes a transmitter(s) 50H for transmitting any of the data, information, video information, audio information, global positioning information, position or location, messages, or any other data or information, to any central processing computer 10, to any social network computers 20, to any user communication devices 30, to any cellular communication service provider computers 40, or to any other premises computers 50, described herein. The transmitter 50H can be or can include one or more separate transmitters or individual transmitters.

In a preferred embodiment, the premises computer 50, also includes a receiver 50I for receiving any of the data, information, video information, audio information, global positioning information, position or location, messages, or any other data or information, from any central processing computer 10, from any social network computers 20, from any user communication devices 30, from any cellular communication service provider computers 40, or from any other premises computer 50, described herein. The receiver 50I can be or can include one or more separate receivers or individual receivers.

In a preferred embodiment, the apparatus 100 and method of the present invention can be utilized to provide information or a notification to an individual or to a user, or to at least one or more individuals or users, regarding a presence of another person at, in, or in the vicinity of, the individual or the user, or at, in, or the vicinity of, a location, place, or venue, where the individual or user is or happens to be present or located.

For example, if a friend, such a social networking friend, of the individual or user happens to be a same sporting event, sporting venue, shopping mall, store, or other place or location, as the individual or user, the apparatus 100 and method of the present invention can detect the presence of both the individual or user, and the friend, at, in, or in the vicinity of, the individual or the user, or at, in, or the vicinity of, a location, place, or venue, where the individual or user is or happens to be present or located, can generate a message to inform the individual or user of the presence of his or her friend as being nearby or at, in, or in the vicinity of, the individual or the user, or at, in, or the vicinity of, a location, place, or venue, where the individual or user is or happens to be present or located, and can transmit the message to the user communication device 30 of, used by, or associated with the individual or user. In this manner, the individual or user can be notified or alerted as to the presence of his or her friend being nearby, and the individual or user can either initiate a communication with the user communication device of, used by, or associated with the friend. The individual or user may also use the information so as to avoid coming into contact with the friend.

In a preferred embodiment, any user who is a member of a social network and who desires to utilize the apparatus 100 and method of the present invention, in order to either be notified regarding the presence, within a pre-determined or a pre-selected distance, range, or radius, of another user or who agrees to have information regarding his, her, or its, presence be provided to other users, can register his, her, or its, cellular telephone number and cellular service provider with the central processing computer 10 and/or the social network computer of the social network to which he, she, or it, belongs. In the case of a company, business entity, venue, or location, or any other user, which may have a stationary location, information regarding its or his or her telephone number, which can be a landline telephone number or a cellular telephone number, address, website, uniform resource locator (url), or any other information, along with its location, can be registered with the central processing computer 10 and/or the social network computer 20 of the social network to which it, belongs.

A user can also identify those other users or members, or groups of users or members, or a social network, of or for any number of social networks with, with whom or which he, she, or it, agrees or desires to utilize the apparatus 100 and method of the present invention in connection with so that he, she, or it, can either be notified regarding the presence of another user or member or to whom or which he, she, or it, agrees or desires to have information regarding his, her, or its, presence provided.

The user can also pre-select or pre-program the distance, range, or radius, within which he, she, or it, desires to be notified of the presence of other users. For example, if the user is attending a sporting event at a stadium, he, she, or it, may select a distance, range, radius, of between 1000 and 2000 feet so as to be notified of any his or her friends who may be attending the same sporting event or at least be nearby same.

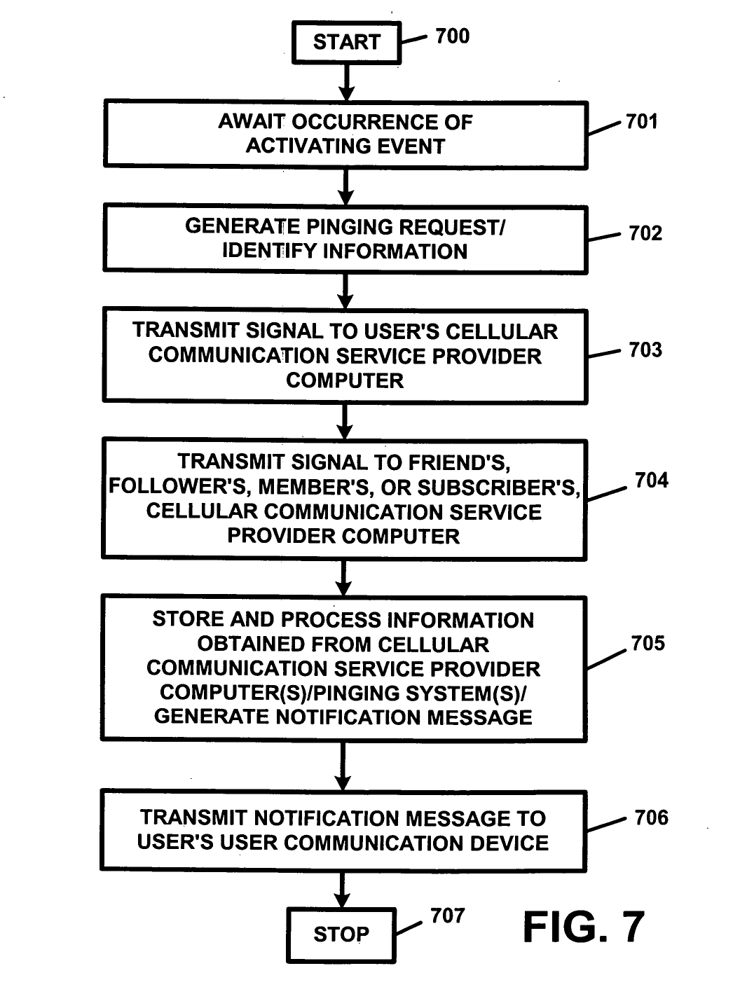

FIG. 7 illustrates a preferred embodiment method for utilizing the apparatus 100, in flow diagram form. With reference to FIG. 7, the operation of the apparatus 100 commences at step 700. At step 701, the apparatus 100 will await an occurrence of an activating event. In the preferred embodiment, the activating event can be initiated by any person or individual authorized to operate or activate the apparatus 100 or authorized to operate or activate the central processing computer 10, by any of the herein-described social networks or by any person or individual authorized to act on behalf of a respective social network, by any person or individual authorized to activate or operate any of the herein-described cellular communication service provider computers 40 or their respective cellular pinging systems, by any of the herein-described users or by any person or individual authorized to act for or on behalf of any of the herein-described users, by any person or individual authorized to act for or on behalf of any of the herein-described premises, or by any person or individual authorized to operate or activate any of the herein-described premises computers 50 (hereinafter “the pinging requestor”).

The activating event can also be programmed or can be pre-selected by the pinging requestor to occur at or during a certain day or time, at or during certain time intervals, prior to, at, during, or after, certain events, social events, or happenings, which can include, but not be limited to, certain days, activities, occasions, events of any kind or type, or at any other occurrence. For example, a user attending for example, a professing sporting event, might desire to know if any of his social networking friends are also at the event, can, as the pinging requestor, program the apparatus 100 or the central processing computer 10 to activate the apparatus 100 before the event, during the event at pre-selected intervals, or after the event, in order to be apprised of the presence of his or her social networking friends.

Upon the activation of the apparatus 100 at step 701, the operation of the apparatus 100 will proceed to step 702 and the central processing computer 10 will generate a pinging request for the pinging requestor and will commence performing a pinging request. In the preferred embodiment example of FIG. 7, the pinging requestor can be any user who is a member of a social network who or which can have any number of friends, followers, or subscribers, or any other social networking designation.

It is important to note, however, that the apparatus 100 of FIG. 7 can be used by, or activated by, any person or individual authorized to operate or activate the apparatus 100 or authorized to operate or activate the central processing computer 10, by any of the herein-described social networks or by any person or individual authorized to act on behalf of a respective social network, by any person or individual authorized to activate or operate any of the herein-described cellular communication service provider computers 40 or their respective cellular pinging systems, by any of the herein-described users or by any person or individual authorized to act for or on behalf of any of the herein-described users, by any person or individual authorized to act for or on behalf of any of the herein-described premises, or by any person or individual authorized to operate or activate any of the herein-described premises computers 50.

At step 702, the central processing computer 10 will identify the pinging requestor, identify the pinging requestor's cellular telephone number and cellular service provider, or the pinging requestor's location and telephone number, and identify the pinging requestor's social network or any number, or all, of the social networks to which the pinging requestor belongs, and identify all users who are friends, followers, members, or subscribers, of or to the user's social network or social networks, and identify, for each of these friends, followers, member, or subscribers, his, her, or its cellular telephone number and cellular service provider. In the case of a friend, follower, member, or subscriber, which may have a stationary location, information regarding its or his or her telephone number, and location can be identified.

At step 703, the central processing computer 10 will, for the user, and for each friend, follower, member, or subscriber, of or to the user's social network or social networks, transmit a signal to the user's cellular communication service provider computer 40 to request that a cellular pinging be performed for the user's cellular telephone in order to determine the location or position of the user's cellular telephone.

In a preferred embodiment, the cellular communication service provider computer 40 can, at step 703, activate the cellular pinging system associated with the user's cellular communication service provider computer 40.

At step 703, the cellular pinging system can determine the location or position of the user's cellular telephone and can provide the determined location or position information to the cellular communication service provider computer 40 which can, in turn, transmit same to the central processing computer 10. Thereafter, the information regarding the location or position of the user's cellular telephone can be stored at the central processing computer 10. In the case of a stationary user, his, her, or its, location or position information can be determined and store without having to perform a pinging operation.

At step 704, the central processing computer 10 can, repeat the process described above as being performed at step 703 in order to determine the location or position of and for each of the identified friends, followers, members, or subscribers, of or to the user's social network or social networks. In this regard, for each identified friend, follower, member, or subscriber, of or to the user's social network or social networks, the central processing computer 10 will transmit a transmit a signal to that friend's, follower's, member's, or subscriber's, cellular communication service provider computer 40 to request that a cellular pinging be performed for that that friend's, follower's, member's, or subscriber's, cellular telephone in order to determine the location or position of the that that friend's, follower's, member's, or subscriber's, cellular telephone.

In a preferred embodiment, the friend's, follower's, member's, or subscriber's, cellular communication service provider computer 40 can, at step 704, activate the cellular pinging system associated with the cellular communication service provider computer 40. At step 704, the respective cellular pinging system can then determine the location or position of the that friend's, follower's, member's, or subscriber's, cellular telephone and can provide the determined location or position information to the respective cellular communication service provider computer 40 which can, in turn, transmit same to the central processing computer 10.

Thereafter, the information regarding the location or position of the cellular telephone for each of the friend's, follower's, member's, or subscriber's, can be stored at the central processing computer 10. In the case of a stationary user, his, her, or its, location or position information can be determined and store without having to perform a pinging operation.

At step 705, the central processing computer 10 will process the stored information regarding the location or position of the cellular telephone of the user along with the information regarding the location or position of the cellular telephone of each of the friend's, follower's, member's, or subscriber's, of the user in order to determine which friend(s), follower(s), member(s), or subscriber(s), of the user is determined to be within the pre-selected distance, range, or radius, for triggering a notification of his, herm, or its, presence to the user.

At step 705, the central processing computer 10 can generate a notification message containing the identify and contact information, which can include the cellular telephone number or e-mail address, of each friend(s), follower(s), member(s), or subscriber(s), of the user who or which is determined to be within the pre-selected distance, range, or radius, of the user. In a case where no friend(s), follower(s), member(s), or subscriber(s), of the user are determined to be within the pre-selected distance, range, or radius, the central processing computer 10 can generate a notification message containing information to that effect.

At step 706, the central processing computer 10 can then transmit the notification message to the user's user communication device 30. The notification message can be transmitted as, or contained in, a text message, or an SMA message, or can be transmitted as, or contained in, an e-mail message transmitted to the user communication device 30 via the user's e-mail server system or e-mail system or network. The notification message can also be transmitted as, or contained in, a telephone call to the user communication device 30. Thereafter, at step 706, the user can then utilize the contact information of each identified friend, follower, member, or subscriber in order to initiate contact with that friend, follower, member, or subscriber. Thereafter the operation of the apparatus 100 will cease at step 707.

In another preferred embodiment, the apparatus 100 or the central processing computer 10, at step 705, can generate a notification message containing the identify and contact information, which can include the cellular telephone number or e-mail address, of the user as well as any friend(s), follower(s), member(s), or subscriber(s), of the user whose presence is detected, and can, at step 706, transmits the notification message to the respective friend(s), follower(s), member(s), or subscriber(s), of the user.

In another preferred embodiment, the apparatus 100 and the central processing computer(s) 10 and the cellular communication service provider computer(s) 30 can be equipped with hardware and software to determine the location or position of any of the user cellular telephones described herein by utilizing triangulation techniques.

Applicant incorporates by reference herein the subject matter and teachings of cellular triangulation technology as of the filing date of the present patent application for the present invention. In the preferred embodiment, each of the cellular communication service provider computers 40 can, for any user of their respective cellular telephone communication network, determine a position or location of that user using cellular triangulation technology which is well know to those skilled in the cellular triangulation technology art or field.

The apparatus 100 and method of the present invention can be utilized in any numbers of applications. Appendix A which is attached hereto, and which is hereby incorporated by reference herein, as if fully restated herein, in its entirety, describes some examples of other uses and applications for the apparatus 100 and method of the present invention.

In another preferred embodiment, the apparatus 100 and method of the present invention can also be used so that an individual or user who is not friends with, or who desires to avoid a detected person, can be notified of the person's presence so that the individual or user may avoid that person.

The apparatus 100 and method of the present invention can be utilized in many social networking applications and can also be utilized in any number or types or kinks of marketing applications, healthcare applications, educational applications, applications involving the offering or the providing or any types or kinds of goods and/or services, and/or in matching buyers with sellers.

While the present invention has been described and illustrated in various preferred and alternate embodiments, such descriptions are merely illustrative of the present invention and are not to be construed to be limitations thereof. In this regard, the present invention encompasses all modifications, variations and/or alternate embodiments, with the scope of the present invention being limited only by the claims which follow.

What is claimed is:

1. An apparatus, comprising:
a processing device, wherein the processing device processes information regarding a pinging request regarding a first user, wherein the processing device stores information regarding a first location or a first position of a first cellular telephone held by or in a vicinity of the first user, and further wherein the processing device stores information regarding a second location or a second position of a second cellular telephone held by or in a vicinity of a second user, wherein the second user is friend, follower, member, or subscriber, of or to the first user, wherein the processing device determines whether the second location or the second position is within a pre-determined or pre-set distance, range, or radius, of the first location or the first position, and, if the second location or the second position is within a pre-determined or pre-set distance, range, or radius, of the first location or the first position, the processing device generates a notification message containing information regarding or identifying the second user and a cellular telephone number of the second cellular telephone or an e-mail address of the second user; and
a transmitter, wherein the transmitter transmits the notification message to the first cellular telephone.

2. A computer-implemented method, comprising:
processing, with or using a processing device or a first computer, information regarding a pinging request regarding a first user;
storing, in a memory device, information regarding a first location or a first position of a first cellular telephone held by or in a vicinity of the first user;
storing, in a memory device, the computer, or a second computer, information regarding a second location or a second position of a second cellular telephone held by or in a vicinity of a second user, wherein the second user is a friend, follower, member, or subscriber, of or to the first user;
determining, with the processing device, the first computer, or the second computer, whether the second location or the second position is within a pre-determined or pre-set distance, range, or radius, of the first location or the first position;
generating, with the processing device, the first computer, or the second computer, a notification message containing information regarding or identifying the second user and a cellular telephone number of the second cellular telephone or an e-mail address of the second user if the second location or the second position is within a pre-determined or pre-set distance, range, or radius, of the first location or the first position;
transmitting, with or from a transmitter, the first computer, or the second computer, the notification message to the first cellular telephone.

3. An apparatus, comprising:
a processing device, wherein the processing device processes information regarding a pinging request regarding a first user, wherein the processing device stores information regarding a first location or a first position of a first communication device in a vicinity of the first user, and further wherein the processing device stores information regarding a second location or a second position of a second communication device held by or in a vicinity of a second user, wherein the second user is a friend, follower, member, or subscriber, of or to the first user, wherein the processing device determines whether the second location or the second position is within a pre-determined or pre-set distance, range, or radius, of the first location or the first position, and, if the second location or the second position is within a pre-determined or pre-set distance, range, or radius, of the first location or the first position, the processing device generates a notification message containing information regarding or identifying the second user and a telephone number of the second communication device or an e-mail address of the second user; and
a transmitter, wherein the transmitter transmits the notification message to the first communication device.

4. The apparatus of claim 3, wherein the first communication device is a cellular telephone.

5. The apparatus of claim 3, wherein the second communication device is a cellular telephone.

6. The apparatus of claim 3, wherein the first communication device or the second communication device is a personal digital assistant.

7. The apparatus of claim 3, wherein the first communication device or the second communication device is a tablet computer.

8. The apparatus of claim 3, wherein the first communication device or the second communication device is a digital television or an interactive television.

9. The apparatus of claim 3, wherein the first communication device or the second communication device is a landline telephone or a cordless telephone.

10. The apparatus of claim 3, wherein the first communication device or the second communication device is a personal computer or a laptop computer.

11. The apparatus of claim 3, wherein the apparatus processes information to identify a requestor of the pinging request, to identify a cellular telephone number and cellular service provider of a requestor of the pinging request, to identify a location or a telephone number of a requestor of the pinging request, or to identify a social network of a requestor of the pinging request.

12. The apparatus of claim 3, wherein the apparatus processes information for requesting that a cellular ping be performed for the first communication device or for the second communication device.

13. The apparatus of claim 3, wherein the apparatus processes information for activating a cellular pinging system associated with the first communication device or he second communication device.

14. The apparatus of claim 13, wherein the apparatus determines or stores a location or position of the first communication device.

15. The apparatus of claim 3, wherein the first communication device or the second communication device is a stationary device, and further wherein the apparatus stores location or position information regarding the first communication device or the second communication device.

16. The apparatus of claim 3, wherein the apparatus determines a location or a position of each of a plurality of identified friends, followers, members, or subscribers, of a social network of the first user.

17. The apparatus of claim 3, wherein the apparatus utilizes a triangulation technique to determine a location or position of the first communication device or the second communication device.

18. The apparatus of claim 3, wherein the notification message is transmitted as, or is contained in, a text message or an SMS message.

19. The apparatus of claim 3, wherein the notification message is transmitted as, or is contained in, an e-mail message.

20. The apparatus of claim 3, wherein the notification message is transmitted as, or is contained in, a telephone call.
